(19) United States
(12) Patent Application Publication
(10) Pub. No.: US 2025/0126545 A1
(43) Pub. Date: Apr. 17, 2025

(54) METHOD, BASE STATION, AND USER EQUIPMENT FOR WIRELESS COMMUNICATION

(71) Applicant: SAMSUNG ELECTRONICS CO., LTD., Suwon-si (KR)

(72) Inventor: Chao Geng, Suzhou (CN)

(21) Appl. No.: 18/796,940

(22) Filed: Aug. 7, 2024

(30) Foreign Application Priority Data
Oct. 12, 2023 (CN) 202311321893.5

(51) Int. Cl. H04W 48/08; H04W 48/16

(52) U.S. Cl. CPC H04W 48/08; H04W 48/16

(57) ABSTRACT

A method, a base station, and a user equipment (UE) for wireless communication are disclosed. The method includes communicating a change message between a base station and a UE indicating that system information is to be changed, the system information including a plurality of system information blocks (SIBs); modifying a scheduling information list included in a system information block type1 (SIB1) of the plurality of SIBs; communicating the SIB1 to the UE; and communicating other SIBs other than the SIB1 among the plurality of SIBs to the UE based on a transmission order of the other SIBs determined by the modified scheduling information list. In some embodiments, the change message may indicate that at least one SIB of the other SIBs is changed.

### TECHNICAL FIELD

The present disclosure relates to wireless communication and, more particularly, to a method, a base station, and a user equipment (UE) for wireless communication.

### DISCUSSION OF RELATED ART

Wireless communication systems are widely deployed for providing various telecommunication services such as telephony, video, data, messaging, broadcasts and so on. In some cases, the wireless communication systems can conform to specifications such as third generation partnership project (3GPP), 3GPP long term evolution (LTE), etc. In order to meet the increasing demand for wireless data communication services since the deployment of 4th generation (4G) and/or LTE communication systems, efforts have been made to develop improved 5th generation (5G) or pre-5G communication systems. Accordingly, in some cases, 5G or pre-5G communication systems are also called “Beyond 4G networks” or “Post-LTE systems”.

Wireless communication is one of the most successful innovations in modern history. A wireless communication system may include a number of devices (e.g., terminals, network devices, and other devices) exchanging data, control information, reference signals, etc. (e.g., communicating) with each other. In some examples, devices operating in a wireless communication system may employ various technologies to improve throughput or achieve a high data rate. These technologies may allow a wireless communication system to support communication between an increasing number of devices, support advanced functionalities at various devices, improve the quality of communication between devices, etc. Recently, the number of subscribers to wireless communication services has exceeded 5 billion, and it continues to grow rapidly. The demand for wireless data services is growing rapidly due to the growing popularity of smartphones and other mobile data apparatuses (e.g., tablets, notebooks, netbooks, e-book readers, and machine-type apparatuses) among consumers and businesses. In order to meet the rapid growth of wireless data services and support new applications and deployments, it is important to improve an efficiency of wireless interface and an accuracy of information transmission.

### SUMMARY

This Summary is provided to introduce a selection of concepts in a simplified form that are further described below in the Detailed Description. This Summary is not intended to identify key features and/or essential features of the claimed subject matter, nor is it intended to be used as an aid in determining the scope of the claimed subject matter.

According to example embodiments of the present disclosure, a method for wireless communication at a base station comprises: transmitting, to a user equipment (UE), a change message indicating that system information is to be changed, the system information comprising a plurality of system information blocks (SIBs); modifying a scheduling information list included in a system information block type1 (SIB1) of the plurality of SIBs; transmitting, to the UE, the SIB1; and transmitting, to the UE, one or more other SIBs other than the SIB1 among the plurality of SIBs based on a transmission order of the one or more other SIBs determined by the modified scheduling information list, where the change message indicates that at least one SIB of the one or more other SIBs is changed.

According to example embodiments of the present disclosure, transmitting the one or more other SIBs to the UE may comprise: periodically transmitting, to the UE, the one or more other SIBs based on the transmission order of the one or more other SIBs determined by the modified scheduling information list.

According to example embodiments of the present disclosure, modifying the scheduling information list may comprise: changing a transmission order of the at least one SIB that is changed to be earlier than a transmission order of remaining SIBs other than the at least one SIB among the one or more other SIBs.

According to example embodiments of the present disclosure, among respective SIBs of the at least one SIB, a sequence relationship embodied by the transmission order of the at least one SIB after the changing may be the same as a sequence relationship embodied by the transmission order of the at least one SIB before the changing, and among respective SIBs of the remaining SIBs, a sequence relationship embodied by the transmission order of the remaining SIBs may be unchanged.

According to example embodiments of the present disclosure, modifying the scheduling information list may comprise: assigning respective priority parameters to the at least one SIB that is changed in the scheduling information list, where the priority parameters indicate that a transmission order of the SIBs to which the priority parameters are assigned is adjusted to be earlier than a transmission order of the SIBs to which the priority parameters are not assigned.

According to example embodiments of the present disclosure, the transmission order of the at least one SIB that is changed may be determined according to values of the respective priority parameters, and among respective SIBs of the at least one SIB, a sequence relationship embodied by the transmission order indicated by the values of the respective priority parameters of the at least one SIB may be the same as a sequence relationship embodied by a transmission order of the at least one SIB before the changing.

According to example embodiments of the present disclosure, transmitting the one or more other SIBs to the UE may comprise: obtaining a time domain location of each SIB of the one or more other SIBs based on the determined transmission order of each SIB of the one or more other SIBs; and transmitting the one or more other SIBs to the UE based on the obtained time domain location of each SIB of the one or more other SIBs.

According to example embodiments of the present disclosure, obtaining the time domain location of each SIB of the one or more other SIBs may comprise: determining a starting radio frame indicating the time domain location of each SIB of the one or more other SIBs, based on the determined transmission order of each SIB of the one or more other SIBs, a SystemInformation (SI) WindowLength included in the SIB1, a time domain length of a single radio frame, a SI Periodicity of each SIB of the one or more other SIBs included in the scheduling information list, or a combination thereof.

According to example embodiments of the present disclosure, determining the starting radio frame of each SIB of the one or more other SIBs may comprise: obtaining an integer value of each SIB of the one or more other SIBs based on the determined transmission order of each SIB of the one or more other SIBs and the SI WindowLength included in the SIB1; and determining the starting radio frame of each SIB of the one or more other SIBs based on the integer value of each SIB of the one or more other SIBs, the time domain length of the single radio frame, the SI Periodicity of each SIB of the one or more other SIBs included in the scheduling information list, or a combination thereof.

According to example embodiments of the present disclosure, transmitting the one or more other SIBs to the UE may comprise: transmitting, to the UE, each SIB of the one or more other SIBs with the SI Periodicity of each SIB of the one or more other SIBs included in the scheduling information list based on the starting radio frame of each SIB of the one or more other SIBs.

According to example embodiments of the present disclosure, obtaining the time domain location of each SIB of the one or more other SIBs may comprise: determining a starting radio sub-frame indicating the time domain location of each SIB of the one or more other SIBs based on the determined transmission order of each SIB of the one or more other SIBs, the SI WindowLength included in the SIB1, a number of radio sub-frames included in the single radio frame, or a combination thereof.

According to example embodiments of the present disclosure, determining the starting radio sub-frame of each SIB of the one or more other SIBs may comprise: obtaining an integer value of each SIB of the one or more other SIBs based on the determined transmission order of each SIB of the one or more other SIBs and the SI WindowLength included in the SIB1; and determining the starting radio sub-frame of each SIB of the one or more other SIBs based on the integer value of each SIB of the one or more other SIBs and the number of radio sub-frames included in the single radio frame.

According to example embodiments of the present disclosure, transmitting the one or more other SIBs to the UE may comprise: determining a starting time domain location for transmitting each SIB of the one or more other SIB, based on the starting radio frame and the starting radio sub-frame of each SIB of the one or more other SIBs; determining a time domain window for transmitting each SIB of the one or more other SIBs based on the starting time domain location for transmitting each SIB of the one or more other SIBs and the SI WindowLength included in the SIB1; and transmitting the one or more other SIBs to the UE through the determined time domain window of each SIB of the one or more other SIBs.

According to example embodiments of the present disclosure, a method for wireless communication at a UE comprises: receiving, from a base station, a change message indicating that system information is to be changed, the system information including a plurality of SIBs; receiving, from the base station, a SIB1 among the plurality of SIBs, the SIB1 including a scheduling information list; determining a reception order of one or more other SIBs other than the SIB1 among the plurality of SIBs based on the scheduling information list; and receiving, from the base station, the one or more other SIBs based on the determined reception order of the one or more other SIBs, where the change message indicates that at least one SIB of the one or more other SIBs is changed.

According to example embodiments of the present disclosure, the receiving the other SIBs from the base station may comprise: periodically receiving, from the base station, the one or more other SIBs based on the determined reception order of the one or more other SIBs, where, when a first portion of the one or more other SIBs is received in a current period, a second portion other than the first portion of the one or more other SIBs received in a previous period is invoked.

According to example embodiments of the present disclosure, a reception order of the at least one SIB that is changed may be earlier than a reception order of remaining SIBs other than the at least one SIB among the one or more other SIBs.

According to example embodiments of the present disclosure, among respective SIBs of the at least one SIB that is changed, a sequence relationship embodied by a reception order of the respective SIBs after the changing may be the same as a sequence relationship embodied by a default reception order of the respective SIBs before the changing.

According to example embodiments of the present disclosure, determining the reception order of the one or more other SIBs based on the scheduling information list may comprise: obtaining priority parameters from the scheduling information list; determining SIBs of the plurality of SIBs to which priority parameters are assigned; and determining a reception order of the SIBs to which priority parameters are assigned to be earlier than a reception order of SIBs to which the priority parameters are not assigned.

According to example embodiments of the present disclosure, determining the reception order of the one or more other SIBs based on the scheduling information list may comprise: determining the reception order of the at least one SIB that is changed based on priority parameters obtained from the scheduling information list; and determining a reception order of remaining SIBs other than the at least one SIB that is changed among the one or more other SIBs based on a default reception order of the remaining SIBs obtained from the scheduling information list, where, among respective SIBs of the remaining SIBs, a sequence relationship embodied by a reception order of the respective SIBs of the remaining SIBs is the same as a sequence relationship embodied by the default reception order of the respective SIBs of the remaining SIBs.

According to example embodiments of the present disclosure, receiving the one or more other SIBs from the base station may comprise: obtaining a time domain location of each SIB of the one or more other SIBs based on the determined reception order of each SIB of the one or more other SIBs; and receiving, from the base station, the one or more other SIBs based on the obtained time domain location of each SIB of the one or more other SIBs.

According to example embodiments of the present disclosure, obtaining the time domain location of each SIB of the one or more other SIBs may comprise: determining a starting radio frame indicating the time domain location of each SIB of the one or more other SIBs based on the determined reception order of each SIB of the one or more other SIBs, a SI WindowLength included in the SIB1, a time domain length of a single radio frame, a SI Periodicity of each SIB of the one or more other SIBs included in the scheduling information list, or a combination thereof.

According to example embodiments of the present disclosure, determining the starting radio frame of each SIB of the one or more other SIBs may comprise: obtaining an integer value of each SIB of the one or more other SIBs based on the determined reception order of each SIB of the one or more other SIBs and the SI WindowLength included in the SIB1; and determining the starting radio frame of each SIB of the one or more other SIBs based on the integer value of each SIB of the one or more other SIBs, the time domain length of the single radio frame, the SI Periodicity of each SIB of the other SIBs included in the scheduling information list, or a combination thereof.

According to example embodiments of the present disclosure, receiving the one or more other SIBs from the base station may comprise: receiving, from the base station, each SIB of the one or more other SIBs with the SI Periodicity of each SIB of the one or more other SIBs included in the scheduling information list based on the starting radio frame of each SIB of the one or more other SIBs.

According to example embodiments of the present disclosure, obtaining the time domain location of each SIB of the one or more other SIBs may comprise: determining a starting radio sub-frame indicating the time domain location of each SIB of the one or more other SIBs based on the determined reception order of each SIB of the one or more other SIBs, the SI WindowLength included in the SIB1, a number of radio sub-frames included in the single radio frame, or a combination thereof.

According to example embodiments of the present disclosure, determining the starting radio sub-frame of each SIB of the one or more other SIBs may comprise: obtaining an integer value of each SIB of the one or more other SIBs based on the determined reception order of each SIB of the one or more other SIBs and the SI WindowLength included in the SIB1; and determining the starting radio sub-frame of each SIB of the one or more other SIBs based on the integer value of each SIB of the one or more other SIBs and the number of radio sub-frames included in the single radio frame.

According to example embodiments of the present disclosure, receiving the other SIBs from the base station may comprise: determining a starting time domain location for receiving each SIB of the one or more other SIBs based on the starting radio frame and the starting radio sub-frame of each SIB of the one or more other SIBs; determining a time domain window for receiving each SIB of the one or more other SIBs based on the starting time domain location for receiving each SIB of the one or more other SIBs and the SI WindowLength included in the SIB1; and receiving, from the base station, the one or more other SIBs through the determined time domain window of each SIB of the one or more other SIBs.

According to example embodiments of the present disclosure, an apparatus for wireless communication at a base station: a transceiver, configured to transmit and receive signals to and from outside the base station; and a processor, configured to control the transceiver to perform the methods for wireless communication described herein.

According to example embodiments of the present disclosure, an apparatus for wireless communication at a UE comprises: a transceiver, configured to transmit and receive signals to and from outside the UE; and a processor, configured to control the transceiver to perform the methods for wireless communication described herein.

Other aspects and/or advantages of the present disclosure will be partially described in the following description, and a part will be apparent through the description and/or may be learned through the practice of some example embodiments.

### BRIEF DESCRIPTION OF THE DRAWINGS

The above and other features of the present disclosure will become more apparent through the following detailed description together with the accompanying drawings in which:

FIG. 1 is a diagram illustrating a wireless communication system according to some example embodiments of the present disclosure;

FIG. 2 is a diagram illustrating a change in system information of the wireless communication system according to some example embodiments of the present disclosure;

FIG. 3 is a flowchart illustrating a method for wireless communication at a base station according to some example embodiments of the present disclosure;

FIG. 4 is a flowchart illustrating a method for wireless communication at a user equipment (UE) according to some example embodiments of the present disclosure; and

FIG. 5 is an example illustrating a scheduling information list according to some example embodiments of the present disclosure.

### DETAILED DESCRIPTION OF THE EMBODIMENTS

A wireless communication system may generally include or refer to a number of devices employing techniques for exchanging information wirelessly. For example, a wireless communication system may include terminals (e.g., user devices or user equipment (UE)) and base stations (or network entities) that wirelessly communicate data, control information, reference signals, etc. (e.g., according to various wireless communication system implementations).

To meet the demand for wireless data traffic having increased since deployment of 4th generation (4G) communication systems, efforts have been made to develop an improved 5th generation (5G) or pre-5G communication system. Therefore, the 5G or pre-5G communication system may also be called a ‘beyond 4G network’ or a ‘post long term evolution (LTE) system’. The 5G communication system may be considered to be implemented in higher frequency (e.g., millimeter wave (mmW)) bands, such as 60 GHz bands, so as to accomplish higher data rates.

Techniques including, for example, beamforming, massive multiple-input multiple-output (MIMO), full dimensional-MIMO (FD-MIMO), array antenna, and analog beam forming may be implemented in 5G communication systems to decrease propagation loss of radio waves and increase transmission distances. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation, and the like.

As part of establishing a communication connection between a UE and a base station (e.g., a cell), the UE may obtain system information (SI) of the base station in order to access the base station and work correctly in the base station. In some embodiments, the SI is cell-level information (e.g., the SI is applicable for all UEs connected to the base station). Additionally, in some embodiments, the SI may include information that indicates how the base station is configured.

The SI may include a Master Information Block (MIB) and a plurality of System Information Blocks (SIBs). As used herein, the SIBs may be divided into a SIB Type1 (SIB1) and other SIBs. For example, the other SIBs may include other types of SIBs other than the SIB1 (e.g., a SIB Type2 (SIB2) up to a SIB Type 24 (SIB24)) and may be hereinafter referred to as SIBXs. The SIB1 may include information related to cell access and cell selection of the base station, a SystemInformation (SI) WindowLength, a scheduling information list, etc. The scheduling information list may include information indicating which SIs exist, a number (i.e., quantity) of the SIs, a period of each SI, and which SIBX(s) are contained in each SI. In some embodiments, the SI may include a set of SIBXs.

The SIs are transmitted and received in a form of messages between the UE and the base station. The SIBXs are carried in SI messages. The mapping of the SIBXs to the SI messages may be flexibly configured through the scheduling information list included in the SIB1. Additionally, each SIBX may be included in a single SI message, and SIBXs with the same scheduling requirements (e.g., same SI Periodicity) may be mapped to a same SI message.

When the base station modifies any SIBX, the base station may notify the UE that the system message is about to be changed (e.g., updated) during a broadcast control channel (BCCH) modification period (but does not transmit the changed content). Subsequently, during an immediately next occurring BCCH modification period, the base station may transmit the changed SIBXs along with the unchanged SIBXs. For example, when the base station modifies any SIBX, the base station may notify the UE that the SI will change in the next BCCH modification period during a preceding BCCH modification period, and the base station may then transmit the unchanged SIBXs and the changed SIBXs to the UE during that next BCCH modification period.

In some embodiments, the base station (e.g., the cell) may transmit a change message during a first BCCH modification period to notify the UE (e.g., a terminal) that the SI is about to change, and after a second BCCH modification period after the first BCCH modification period arrives, the UE may read all SIBXs (e.g., including the unchanged SIBXs and the changed SIBXs) received during the second BCCH modification period. That is, after the UE receives the change message, the UE may receive all SIBXs from the beginning of the next BCCH modification period. In prior art, base stations may notify the UE of changes in the SI instead of notifying which SIBXs have changed. Therefore, after receiving the change message that the SI has changed, the UE will re-receive all SIBXs according to the scheduling information in the SIB1. If a current signal strength is deteriorating, the UE may not be able to decode the changed SIBXs in time, resulting in the reducing of the efficiency of the wireless interface and the accuracy of information transmission.

As described herein, when the base station indicates a change in SI is about to occur (e.g., via a change message) to a UE, the base station may implicitly indicate which SIBXs have been updated or changed, thereby increasing a probability of the UE correctly decoding and receiving all of the SIBXs and the SI. For example, the base station may update or change a transmission order of the SIBXs such that the SIBXs that have been updated or changed are transmitted before any SIBXs that remain unchanged. In some embodiments, the base station may assign priority parameters to the SIBXs that have been updated or changed, where the priority parameters enable the updated or changed SIBXs to be transmitted prior to the SIBXs that are unchanged. Accordingly, by having the changed SIBXs transmitted prior to the unchanged SIBXs, the UE may have a higher probability of receiving and decoding the changed SIBXs if the channel begins to deteriorate and later received SIBXs (e.g., that are unchanged from previous SI transmissions) are impacted by the deteriorating channel conditions, thereby increasing reliability and throughput of SI transmissions.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of the present application. For example, the sequences of operations described herein are examples and are not limited to those set forth herein but may be changed as will be apparent after an understanding of disclosure of the present application, unless the context clearly indicates otherwise. Additionally, descriptions of features that are known in the art may be omitted for increased clarity and conciseness.

The features described herein may be embodied in different forms and are not to be construed as being limited to the examples described herein. Rather, the examples described herein have been provided to illustrate some of the many possible ways of implementing the methods, apparatuses, and/or systems described herein that will be apparent after an understanding of the disclosure of the present application.

The following structural or functional descriptions of examples disclosed herein are intended for the purpose of describing the examples and the examples may be implemented in various forms. The examples are not meant to be limited, but it is intended that various modifications, equivalents, and alternatives are also covered within the scope of the claims.

Although terms of “first” or “second” may be used to explain various components, the components are not limited to the terms. These terms are used to distinguish one component from another component. For example, a “first” component may be referred to as a “second” component, or similarly, and the “second” component may be referred to as the “first” component.

It will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components, or a combination thereof, but do not preclude the presence or addition of one or more other features, integers, steps, operations, elements, components, and/or groups thereof.

Unless otherwise defined, all terms including technical or scientific terms used herein have the same or similar meaning as commonly understood by one of ordinary skill in the art to which the examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements (or similar elements) will be designated by the same reference numerals (or similar reference numerals), and redundant descriptions thereof will be omitted.

As used within this document, the term “communicate” is intended to include transmitting, or receiving, or both transmitting and receiving. This intention may be particularly useful in the present disclosure when describing the organization of data that is being transmitted by one device and received by another, but the functionality of one of those devices is required to infringe the present disclosure. Similarly, the bidirectional exchange of data between two devices (e.g., both devices transmit and receive during the exchange) may be described as “communicating” when the functionality of one of those devices is being claimed. The term “communicating” as used herein with respect to a wireless communication signal may include transmitting the wireless communication signal and/or receiving the wireless communication signal. For example, a wireless communication unit, which is capable of communicating a wireless communication signal, may include a wireless transmitter configured to transmit the wireless communication signal to at least one other wireless communication unit and/or a wireless communication receiver configured to receive the wireless communication signal from at least one other wireless communication unit.

Some embodiments may be used in conjunction with various devices and systems, such as, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates a Radio Frequency Identification (RFID) element or chip, a MIMO transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., a Smartphone, a Wireless Application Protocol (WAP) device), or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2nd generation (2G), 2nd and a half generation (2.5G), 3rd generation (3G), 3rd and a half generation (3.5G), 4G, 5G mobile networks, third generation partnership project (3GPP), LTE, LTE advanced, Enhanced Data rates for GSM Evolution (EDGE), or the like. Other embodiments may be used in various other devices, systems, and/or networks.

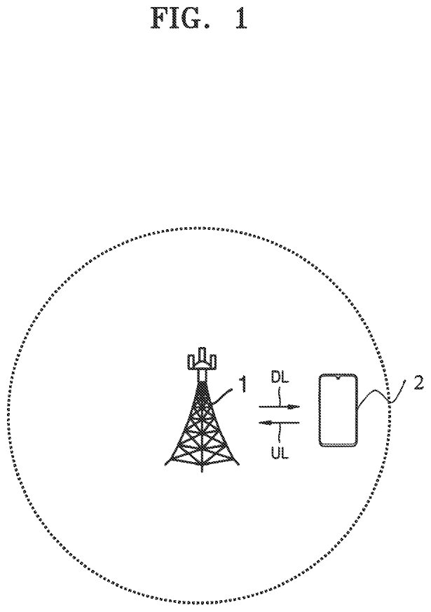

FIG. 1 is a diagram illustrating a wireless communication system according to some example embodiments of the present disclosure.

Some examples of the wireless communication system include a cellular network, such as a 5G system, an LTE system, an LTE-Advanced system, a CDMA system, a GSM system, a Wireless Personal Area Network (WPAN) system, or a combination thereof. Hereinafter, although descriptions will be made with main reference to a wireless communication system using a cellular network, it will be understood that embodiments of the present disclosure are not limited thereto and may be applied to any suitable wireless communication system.

In the example of FIG. 1, a base station 1 may communicate with a UE 2. For example, the base station 1 may generally refer to a fixed station communicating with the UE 2 and/or another base station and may exchange data and control information by communicating with the UE 2 and/or the other base station. In some aspects, the base station 1 may be referred to as a Node B, an evolved-Node B (eNB), a next generation Node B (gNB), a sector, a site, a base transceiver system (BTS), an AP, a relay node, a remote radio head (RRH), a radio unit (RU), a small cell, or the like. Additionally, as used herein, the term “base station” or “cell” may have a comprehensive meaning representing some areas or functions covered by a base station controller (BSC) in CDMA, a Node-B in WCDMA, an eNB in LTE, a gNB of 5G, a sector (site), or the like, and may include all various coverage areas, such as megacell, macrocell, microcell, picocell, femtocell, relay node, RRH, RU, and small cell communication ranges.

The UE 2 may refer to any wireless communication equipment which may be stationary or mobile and may transmit and/or receive data and/or control information by wirelessly communicating with a base station, such as the base station 1. For example, the UE 2 may be referred to as a terminal, a terminal equipment, a mobile station (MS), a mobile terminal (MT), a user terminal (UT), a subscriber station (SS), a wireless device, a handheld device, or the like. Hereinafter, although the use of the wireless communication device as UE 2 will be described mainly by reference, it will be understood that embodiments of the present disclosure are not limited thereto.

A wireless communication network between the UE 2 and the base station 1 may support a large number of users to communicate with each other by sharing available network resources. For example, in the wireless communication network, information may be transferred by various multiple access schemes, such as CDMA, Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, OFDM-CDMA, and the like.

As shown in FIG. 1, the UE 2 may communicate with the base station 1 through an uplink (UL) and a downlink (DL). However, it will be understood that the ways in which the UE 2 communicates with the base station 1 are not limited thereto. In some embodiments, as in D2D communication, UEs may communicate with each other through a sidelink.

The base station 1 may include components of a transceiver, a processor, and the like. In some aspects, the transceiver may be configured to transmit and receive signals to and from the outside (e.g., outside the base station 1), and the processor may be configured to control the transceiver to perform methods for wireless communication. Similarly, the UE 2 may include components of a transceiver, a processor, and the like. In some aspects, the transceiver may be configured to transmit and receive signals to and from the outside (e.g., outside the UE 2), and the processor may be configured to control the transceiver to perform methods for wireless communication.

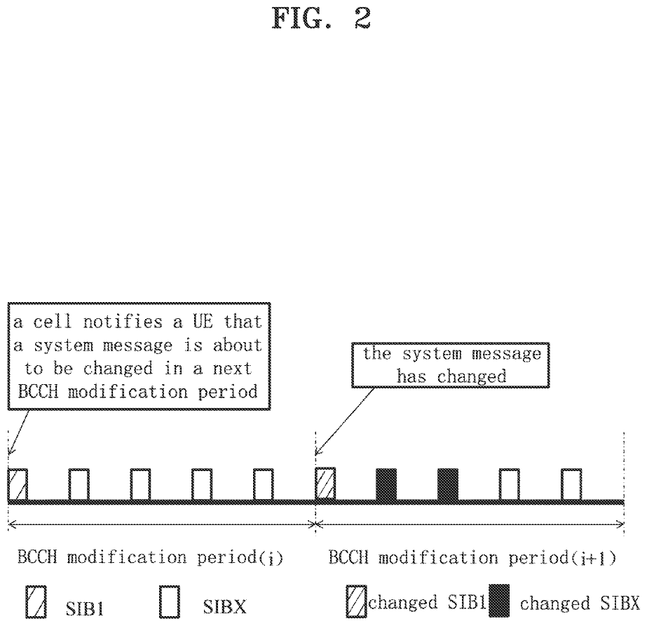

FIG. 2 is a diagram illustrating a change in system information of the wireless communication system according to some example embodiments of the present disclosure. In some examples, the diagram illustrating a change in system information of the wireless communication system as described with reference to FIG. 2 may implement aspects of or may be implemented by aspects of FIG. 1. For example, a base station or cell and a UE may communicate based on a change in system information as described with reference to FIG. 2.

In the process of establishing a communication connection between a UE and a cell (e.g., a base station), the UE may obtain system information of the cell in order to access the cell and work correctly in the cell. In some embodiments, the system information is cell-level information (e.g., the system information is applicable for all UEs connected to the cell). Additionally, in some embodiments, the system information may include information that indicates how the cell is configured.

The system information may include a Master Information Block (MIB) and a plurality of System Information Blocks (SIBs). As used herein, the SIBs may be divided into a SIB Type1 (SIB1) and other SIBs. For example, the other SIBs may include other types of SIBs other than the SIB1 (e.g., a SIB Type2 (SIB2) to a SIB Type24 (SIB24)) and may be hereinafter referred to as SIBXs. In some embodiments, the SIB1 may include SIB scheduling information related to the SIBXs (e.g., which cycles the SIBXs are transmitted after the SIB1). For example, the SIB1 may include information related to cell access and cell selection, a SystemInformation (SI) WindowLength (e.g., time domain window length defined for enabling multiple transmissions of SI messages within the window, such as 1, 2, 5 10, 15, 20 or 40 milliseconds (ms)), a scheduling information list, etc. The scheduling information list may include information indicating which SIs exist (e.g., the SIB types), a number (i.e., quantity) of the SIs, a period of each SI, which SIBX(s) are contained in each SI, etc. Additionally, in some aspects, the SI may include a set of SIBXs.

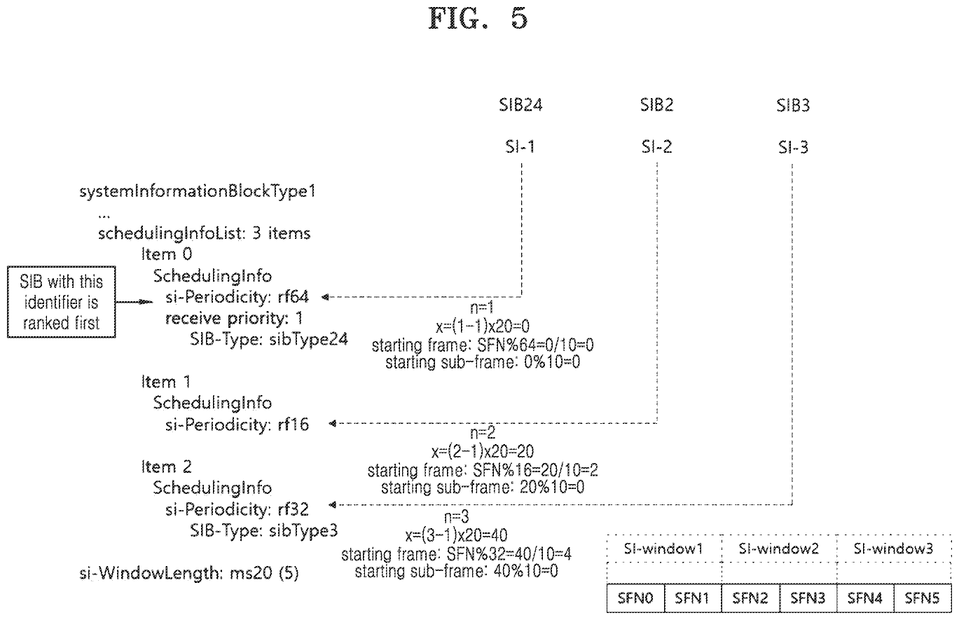

The SI is transmitted and received in a form of messages between the UE and the base station. The SIBXs are carried in SI messages. The mapping of the SIBXs to the SI messages may be flexibly configured through the scheduling information list included in the SIB1. Additionally, each SIBX may be included in a single SI message, and SIBXs with the same scheduling requirements (e.g., SI Periodicity) may be mapped to the same SI message. The SI Periodicity of any SIBX may indicate the scheduling periods of any SIBX in a frame (e.g., a radio frame). In some examples, the SI Periodicity of any SIBX may be represented by rfm, where m is a positive integer. For example, rfm may indicate that the any SIBX is transmitted at a starting frame, at the starting frame +m frames, at the start frame +2m frames, etc. As an exemplary embodiment and as will be described with reference to FIG. 5, a SIB24 may be mapped to a first SI message (SI-1), a SIB2 may be mapped to a second SI message (SI-2), and a SIB3 may be mapped to a third SI message (SI-3).

When the cell modifies any SIBX, the cell may notify the UE that the system message is about to be changed (e.g., updated) during a broadcast control channel (BCCH) modification period (e.g., but does not transmit the changed content). Subsequently, during an immediately next BCCH modification period, the cell may transmit the changed SIBXs along with the unchanged SIBXs. Referring to FIG. 2, during a given BCCH modification period (i) and when the cell modifies any SIBX, the cell may notify the UE that the SI will change in the next BCCH modification period (i+1), where i is a positive integer, and the cell may then transmit the unchanged SIBXs and the changed SIBXs to the UE during the next BCCH modification period (i+1). That is, the cell (e.g., the base station) may transmit a change message during the given BCCH modification period (i) to notify a terminal (e.g., the UE) that the SI is about to change, and after the next BCCH modification period (i+1) arrives, the UE may read all SIBXs (e.g., including the unchanged SIBXs and the changed SIBXs).

After the UE receives the change message (e.g., in the given BCCH modification period (i)), the UE may receive all SIBXs from the beginning of the next BCCH modification period (i+1). In prior art, cells notify the UE changes in the system message instead of notifying which SIBXs have changed. Accordingly, after receiving the change message that the system message has changed, the UE will re-receive all SIBXs according to the scheduling information in the SIB1. If a current signal strength is deteriorating, the UE may not be able to decode the changed SIBXs in time, resulting in reducing efficiency of the wireless interface and the accuracy of information transmission.

For example, if the UE is moving towards a current radio access technology (RAT) (e.g., Unlimited Access Technology) coverage edge and the channel environment gradually deteriorates, the cell may modify the system information (e.g., information related to the system parameter reselection, hereinafter referred to as reselection information). During the process of receiving the modified system information in the next BCCH modification period (i+1), due to the channel conditions deteriorate, the UE may be able to decode the SIBXs that have not changed but may be unable to successfully decode the changed SIBXs (e.g., including the reselection information). Subsequently, as the UE approaches the coverage edge of the current RAT, the channel conditions may no longer support the UE to continue decoding the SIBXs, resulting in the UE not decoding the changed SIBXs and the reselection information. Accordingly, the UE may be unable to complete the cell reselection in time, thereby reducing the efficiency of the wireless interface and the accuracy of information transmission.

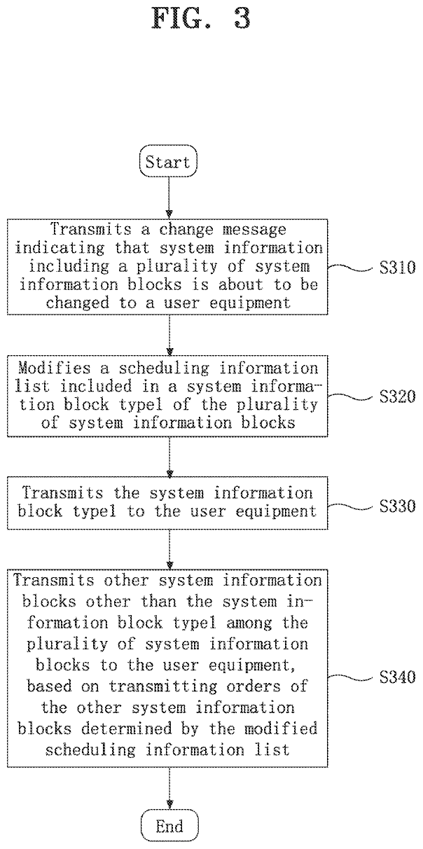

FIG. 3 is a flowchart illustrating a method for wireless communication performed by a base station according to some example embodiments of the present disclosure. In some examples, the flowchart illustrating a method for wireless communication performed by a base station as described with reference to FIG. 3 may implement aspects of or may be implemented by aspects of FIGS. 1 and 2. For example, a base station or cell as described with reference to FIGS. 1 and 2 may employ the method for wireless communication illustrated by the flowchart of FIG. 3.

As illustrated in FIG. 3, in an operation S310, the base station may transmit a change message to a UE, where the change message indicates that SI is about to be changed. In some embodiments, the SI may include a plurality of SIBs, where the plurality of SIBs further includes at least an SIB1 and one or more SIBXs. As described herein, the change message may be used to indicate that at least one SIBX of the SIBXs (e.g., other than the SIB1 among the plurality of SIBs) is changed.

When the base station is about to change the SI, the base station may transmit a change indication of the SI to the UE. The change indication may indicate whether one or more SIBs of the plurality of SIBs included in the SI have changed. The change indication of the SI may be transmitted through change messages (e.g., paging messages containing systemInfoModification but is not limited thereto). In some example embodiments of the present disclosure, in a current BCCH modification period (e.g., a BCCH modification period (i) as described with reference to FIG. 2), the base station may transmit a paging message with a systemInforModification field indicating that the SI is about to change. Additionally or alternatively, the base station may transmit the change indication of the SI through other messages (e.g., waking up messages, power saving messages, etc.), but the example embodiments of present disclosure are not limited thereto. During the current BCCH modification period (e.g., after transmitting the change indication but prior to the next occurring BCCH modification period), the base station may transmit the original (e.g., or default) SIBs to the UE.

As illustrated in FIG. 3, in an operation S320, the base station may modify the scheduling information list included in the SIB1 of the plurality of SIBs, thereby changing a transmission order of the changed SIBXs.

In some example embodiments of the present disclosure, the base station may change the transmission order of the changed SIBXs by changing a transmission order of at least one SIBX that has changed among the SIBXs. For example, the base station may change the transmission order of the at least one changed SIBX to be transmitted earlier than the transmission order of the remaining SIBXs among the SIBXs (e.g., other than the at least one SIB that has changed). In other words, the base station may change the transmission order(s) of the changed SIBX(s) by changing a transmission order of the at least one changed SIBX to occur earlier than a transmission order of the unchanged SIBXs. Among SIBXs of the changed SIBXs (e.g., if multiple SIBXs are changed), a sequence relationship embodied by the transmission order of the changed SIBXs after the changing is the same as a sequence relationship embodied by the transmission order of the changed SIBXs before the changing. For example, if a transmission order of a first SIBX of the changed SIBXs is earlier than a transmission order of a second SIBX of the changed SIBXs before the scheduling information list is modified, the transmission order of the first SIBX is still earlier than the transmission order of the second SIBX after the scheduling information list is modified.

Additionally, among respective SIBXs of the remaining SIBXs (e.g., the SIBXs that are unchanged), a sequence relationship embodied by the transmission order of the remaining SIBXs is unchanged. In other words, among the respective SIBXs of the remaining SIBXs that have been unchanged, the sequence relationship embodied by the transmission order of the remaining SIBXs is the same as a sequence relationship embodied by a default transmission order of the remaining SIBXs. For example, if a transmission order of a third SIBX of the remaining SIBXs is earlier than a transmission order of a fourth SIBX of the remaining SIBXs before the scheduling information list is modified, the transmission order of the third SIBX is still earlier than the transmission order of the fourth SIBX after the scheduling information list is modified.

Additionally or alternatively, in some example embodiments of the present disclosure, priority parameters may be assigned to the at least one changed SIBX in the scheduling information list. The priority parameters may indicate that a transmission order of the SIBXs to which the priority parameters are assigned are adjusted to be earlier than a transmission order of the SIBXs to which priority parameters are not assigned. In some embodiments, the scheduling information list may include default order information indicating the default transmission order of each SIBX (e.g., an order list indicating the default order). In this example embodiment, additional priority parameters may be assigned to the changed SIBX(s) without changing the default order information of the SIBXs, thereby indicating new orders of the SIBXs through the default order information and the additionally assigned priority parameters. In this case, the transmission order of the SIBXs to which the priority parameters are additionally assigned (e.g., the changed SIBXs) may be earlier than the a transmission order of the SIBXs to which the priority parameters are not additionally assigned (e.g., the unchanged SIBXs).

Among respective SIBXs of the changed SIBXs, the transmission order of the respective SIBXs may be determined according to values of respective priority parameters assigned to the changed SIBXs. Additionally, a sequence relationship embodied by the transmission order indicated by the values of the respective priority parameters of the respective SIBXs of the changed SIBXs may be the same as a sequence relationship embodied by the default transmission order of the respective SIBXs. For example, the sequence relationship embodied by the transmission order indicated by the values of the respective priority parameters of the respective SIBXs of the changed SIBXs may be the same as the sequence relationship embodied by the transmission order of the respective SIBXs before the changing.

In one example embodiment of the present disclosure, a transmission order of a plurality of SIBXs other than the SIB1, such as a SIB2, a SIB3, a SIB4, a SIB5, and a SIB6, before the changing may be 1 (i.e., first) for the SIB2, 2 (i.e., second) for the SIB3, 3 (i.e., third) for the SIB4, 4 (i.e., fourth) for the SIB5, and 5 (i.e., fifth) for the SIB6. That is, the plurality of SIBXs may be transmitted in the sequence of SIB2, SIB3, SIB4, SIB5, and SIB6 based on the sequence relationship. Subsequently, if the base station changes the SIB3 and the SIB5, the base station may additionally assign a first priority parameter (e.g., 1) to the SIB3 and may assign a second priority parameter (e.g., 2) to the SIB5 in the scheduling information list. Accordingly, after the changing, the transmission order of the plurality of SIBXs other than the SIB1 (e.g., SIB2, SIB3, SIB4, SIB5, and SIB6) may be 2, 4, 1, 3, and 5 based on the sequence relationship before the changing in conjunction with the assigned priority parameters. That is, the plurality of SIBXs may be transmitted in the sequence of SIB3 (e.g., based on the first assigned priority parameter), SIB5 (e.g., based on the second assigned priority parameter), SIB2, SIB4, and SIB6 (e.g., based on the sequence relationship). It should be understood that priority parameters may be assigned in various ways not expressly described herein to reflect the priorities of the transmission order.

In the present disclosure, the changed SIBX(s) may be assigned priority parameter(s), and the unchanged SIBX(s) may not be assigned priority parameter(s) in the scheduling information list. Therefore, there is no additional overhead for unchanged SIBXs in the scheduling information list.

In example embodiments of the present disclosure, the base station may adjust the transmission order of the SIBXs by assigning the additional priority parameters in the scheduling information list; however, the present disclosure is not limited thereto. For example, in another example embodiment, the base station may adjust the transmission order of the SIBXs by modifying other parameters (e.g., an item number as illustrated in the example of FIG. 5) in the scheduling information list. Additionally or alternatively, in another example embodiment, the base station may adjust the transmission order of the SIBXs by directly adjusting the default order information in the scheduling information list (e.g., the sequence relationship of the SIBXs). Additionally or alternatively, the base station may adjust a transmission order of the SIBXs by other ways known to those skilled in the art.

As illustrated in FIG. 3, in an operation S330, the base station may transmit an SIB1 to the UE. For example, after the scheduling information list included in the SIB1 is modified, the base station may transmit the SIB1 including the modified scheduling information list to the UE.

As illustrated in FIG. 3, in an operation S340, the base station may transmit SIBXs to the UE based on the transmission order of the SIBXs determined by the modified scheduling information list transmitted in the SIB1. For example, after the base station transmits the SIB1 including the modified scheduling information list to the UE, the base station may transmit the SIBXs other than the SIB1 to the UE based on the transmission order of the SIBXs determined by the modified scheduling information list.

In example embodiments of the present disclosure, the base station may periodically transmit the SIBXs to the UE based on the transmission order of the SIBXs determined by the modified scheduling information list. For example, referring to FIG. 2, the base station may transmits the SIBXs to the UE based on the transmission order of the SIBXs determined by the modified scheduling information list during the BCCH modification period (i+1) and transmits the SIBXs to the UE based on the same transmission order of the SIBXs during a subsequent BCCH modification period (i+2).

In some example embodiments, the base station may obtain a time domain location of each SIBX based on the determined transmission order of each SIBX and may transmit each SIBX to the UE based on the obtained time domain location of each SIBX. The time domain location may be determined by obtaining a start radio frame and/or a starting radio sub-frame using the transmission order of the SIBXs.

In one example embodiment of the present disclosure, the base station may determine the starting radio frame and/or subframe indicating the time domain location of each SIBX based on the determined transmission order of each SIBX, a SI WindowLength included in the SIB1, a time domain length of a single radio frame, a SI Periodicity of single SIBX included in the scheduling information list, or a combination thereof.

Additionally or alternatively, in some embodiments, the base station may obtain an integer value of each SIBX (e.g., the integer value of each SIBX may indicate a parameter for scheduling each SIBX) based on the determined transmission order of each SIBX and the SI WindowLength included in the SIB1 and may determine the starting radio frame and/or subframe of each SIBX based on the integer value of each SIBX, the time domain length of the single radio frame, the SI Periodicity of each SIBX included in the scheduling information list, or a combination thereof. In some embodiments, each SIBX may be transmitted with the SI Periodicity of each SIBX included in the scheduling information list based on the starting radio frame of each SIBX. The integer value of each SIBX may be determined by Equation 1 given below.

$$x = ( n - 1 ) \times w \qquad ( 1 )$$

In Equation 1, x represents the integer value of each SIBX, n represents the determined transmission order of each SIBX, and w represents the SI WindowLength included in the SIB1.

The starting radio frame SFN of each SIBX may be determined by Equation 2 given below.

$$SFN mod T = FLOOR ( x \div N ) \qquad ( 2 )$$

In Equation 2, mod represents a remainder function (%), FLOOR represents a rounding down function, T represents the SI Periodicity of each SIBX, and N represents the time domain length of the single radio frame.

For example, when a transmission order of a SIB24 is determined to be n=1, the SI WindowLength is configured to be w=20, the SI Periodicity of the SIB24 is configured to be rf64, and the time domain length of the single radio frame is configured to be N=10 ms, the integer value of the SIB24 may be calculated as x=(1−1)×20=0 based on Equation 1, and the starting radio frame of the SIB24 may be calculated as SFN % 64=FLOOR (0/10)=0 based on Equation 2. That is, the SIB24 may be transmitted starting at radio frame 0, radio frame 64, and radio frame 128.

In some embodiments, each SIBX may be transmitted with the SI Periodicity of each SIBX included in the scheduling information list based on the starting radio sub-frame of each SIBX. For example, the base station may determine the starting radio sub-frame of each SIBX indicating the time domain location of each SIBX based on the determined transmission order of each SIBX, the SI WindowLength included in the SIB1, the number (i.e., quantity) of radio sub-frames included in the single radio frame (e.g., the single radio frame may include a plurality of radio sub-frames), or a combination thereof. In some embodiments, the base station may obtain the integer value of each SIBX based on the determined transmission order of each SIBX and the SI WindowLength included in the SIB1 and may determine the starting radio sub-frame of each SIBX based on the integer value of each SIBX and the number of radio sub-frames included in the single radio frame. The starting radio sub-frame a of each SIBX may be determined by Equation 3 given below.

$$A = x mod S \qquad ( 3 )$$

In Equation 3, x represents the integer value of each SIBX calculated based on Equation 1, and S may represent the number of radio sub-frames included in the single radio frame.

Combining Equations 1, 2, and 3, when the transmission order of the SIB24 is determined to be n=1, the SI WindowLength is configured to be w=20, the SI Periodicity of the SIB24 is configured to be rf64, and the number of radio sub-frames included in the single radio frame is configured to be S=10, the integer value of the SIB24 is calculated as x=(1−1)×20=0 based on Equation 1, the starting radio frame of the SIB24 is calculated as SFN % 64=FLOOR (0/10)=0 based on Equation 2, and the starting radio sub-frame of the SIB24 is calculated as SFN #a=0 mod 10=0 based on Equation 3. That is, the SIB24 may be transmitted starting at radio sub-frame 0 of radio frame 0, radio sub-frame 0 of radio frame 64, and radio sub-frame 0 of radio frame 128.

In some embodiments, each SIBX may be transmitted with the SI Periodicity of each SIBX included in the scheduling information list based on the starting radio frame and the starting radio sub-frame of each SIBX. For example, the base station may determine the starting time domain location of transmitting each SIBX based on the starting radio frame and the starting radio sub-frame of each SIBX, may determine a time domain window for transmitting each SIBX based on the starting time domain location and the SI WindowLength of each SIBX, and may transmit each SIBX to the UE through the determined time domain window of each SIBX.

Although the present disclosure uses the above transmitting operations to transmit the SIBXs based on a determined transmission order of each SIBX, example embodiments are not limited thereto, and the present disclosure may use other transmitting operations known to those skilled in the art to transmit the SIBXs based on a determined transmission order of each SIBX.

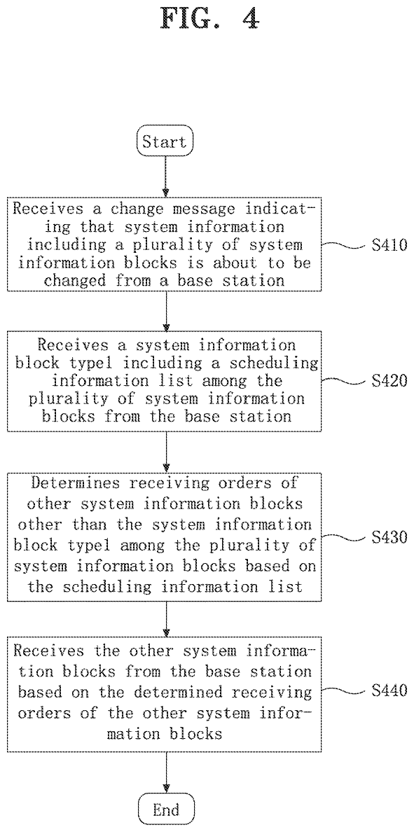

FIG. 4 is a flowchart illustrating a method for wireless communication performed by a UE according to some example embodiments of the present disclosure. In some examples, the flowchart illustrating a method for wireless communication performed by a UE as described with reference to FIG. 4 may implement aspects of or may be implemented by aspects of FIGS. 1-3. For example, a UE or terminal as described with reference to FIGS. 1-3 may employ the method for wireless communication illustrated by the flowchart of FIG. 4.

As illustrated in FIG. 4, in an operation S410, the UE may receive a change message from the base station, where the change message indicates that SI is about to be changed. In some embodiments, the SI may include a plurality of SIBs, where the plurality of SIBs further includes at least an SIB1 and one or more SIBXs. As described herein, the change message may be used to indicate that the at least one SIBX of the SIBXs (e.g., other than the SIB1 among the plurality of SIBs) is changed. After the base station transmits the change message indicating that SI including the plurality of SIBs is about to be changed to the UE, the UE may receive this change message from the base station.

As illustrated in FIG. 4, in an operation S420, the UE may receive an SIB1 including the scheduling information list among the plurality of SIBs from the base station. As described in the present disclosure, the base station may modify the scheduling information list included in the SIB1 and may transmit the SIB1 including the modified scheduling information list to the UE. Accordingly, the UE may receive the SIB1 including this scheduling information list from the base station.

As illustrated in FIG. 4, in an operation S430, the UE may determine a reception order of the SIBXs based on the scheduling information list.

In some example embodiments of the present disclosure, a reception order of the at least one changed SIBX among the SIBXs may be earlier than a reception order of the remaining SIBXs (e.g., other than the at least one changed SIBX among the SIBXs). In other words, a reception order of the at least one changed SIBX may be earlier than a reception order of the unchanged SIBXs. Further, among respective SIBXs of the changed SIBXs (e.g., if multiple SIBXs are changed), a sequence relationship embodied by the reception order of the respective SIBXs may be the same as a sequence relationship embodied by a default reception order of the respective SIBXs.

In one example embodiment of the present disclosure, the UE may obtain priority parameters from the scheduling information list, may determine the SIBXs to which the priority parameters are assigned, and may determine a reception order of the SIBXs to which priority parameters are assigned to be earlier than a reception order of the SIBXs to which priority parameters are not assigned. For example, the UE may determine the reception order of the at least one changed SIBX based on the priority parameters obtained from the scheduling information list and may obtain a default reception order of the remaining SIBXs other than the at least one changed SIBX among the SIBXs. Among the respective SIBXs of the remaining SIBXs (e.g., the unchanged SIBX(s)), a sequence relationship embodied by the reception order of the respective SIBXs of the remaining SIBXs may be determined to be the same as a sequence relationship embodied by the default reception order of the respective SIBXs of the remaining SIBXs.

Although it is illustrated herein that the UE obtains the priority parameters from the scheduling information list to determine the reception order of the SIBXs, the present disclosure is not limited thereto, and the UE may obtain other parameters (e.g., the item number as illustrated in the example of FIG. 5) from the scheduling information list to determine the reception order of SIBXs.

In example embodiments of the present disclosure it should be understood that a transmission order for transmitting the SIBXs to the UE may correspond to (e.g., be the same as) a reception order for receiving the SIBXs from the base station. For example, when the base station transmits the SIBXs to the UE in a transmission order of SIB7, SIB5, SIB6, and SIB8, the UE correspondingly receives the SIBXs from the base station in a reception order of SIB7, SIB5, SIB6, and SIB8.

As illustrated in FIG. 4, in an operation S440, the UE may receive the SIBXs from the base station based on the determined reception order of the SIBXs.

In example embodiments of the present disclosure, the UE may periodically receive the SIBXs from the base station based on the determined reception order of the SIBXs. For example, referring to FIG. 2, the UE may receive the SIBXs from the base station based on the determined reception order of the SIBXs during the BCCH modification period (i+1) and may receive the SIBXs from the base station based on the determined same reception order of the SIBXs during a subsequent BCCH modification period (i+2). When a portion of SIBXs is received and the remaining portion of SIBXs is not received (e.g., the remaining portion of SIBXs is lost) at a present period, the UE may use SIBXs corresponding to the remaining portion of SIBXs received during the previous period (e.g., the period after the last change message was received) as the remaining portion of SIBXs at the present period. For example, when the transmission of the SI is interrupted due to an interruption in either the base station or the UE, the UE may invoke previously received SIBXs to supplement missing SIBXs in the SI, such that the SI including the plurality of SIBs is complete.

When the UE receives the SIBXs from the base station, the UE may obtain the time domain location of each SIBX based on the determined reception order of each SIBX, and the UE may receive the SIBXs from the base station based on the obtained time domain location of each SIBX. In some embodiments, the UE may determine the time domain location by obtaining the starting radio frame and/or the starting radio sub-frame using the reception order of the SIBXs.

In one example embodiment of the present disclosure, the UE may determine the starting radio frame indicating the time domain location of each SIBX based on the reception order of each SIBX, the SI WindowLength included in the SIB1, the time domain length of the single radio frame, the SI Periodicity of each SIBX included in the scheduling information list, or a combination thereof.

For example, the UE may obtain the integer value of each SIBX based on the determined reception order of each SIBX and the SI Window Length included in the SIB1 and may determine the starting radio frame of each SIBX based on the integer value of each SIBX, the time domain length of the single radio frame, the SI Periodicity of each SIBX included in the scheduling information list, or a combination thereof. The UE may receive each SIBX with the SI Periodicity of each SIBX included in the scheduling information list based on the starting radio frame of each SIBX. In some embodiments, the UE may determine the integer value of each SIBX and the starting radio frame of each SIBX based on Equation 1 and Equation 2 given above.

In another example embodiment of the present disclosure, the UE may determine the starting radio sub-frame (e.g., indicating the time domain location of each SIBX) of each SIBX based on the determined reception order of each SIBX, the SI WindowLength included in the SIB1, the number of radio sub-frames included in the single radio frame (e.g., the single radio frame may include a plurality of radio sub-frames), or a combination thereof. For example, the UE may obtain the integer value of each SIBX based on the determined reception order of each SIBX and the SI WindowLength included in the SIB1 and may determine the starting radio sub-frame of each SIBX based on the integer value of each SIBX and the number of radio sub-frames included in the single radio frame. The UE may receive each SIBX with the SI Periodicity of each SIBX included in the scheduling information list based on the starting radio frame and the starting radio sub-frame of each SIBX. In some embodiments, the UE may determine the integer value of each SIB, the starting radio frame of each SIB, and the starting radio sub-frame of each SIB based on Equations 1, 2, and 3 given above.

Accordingly, the UE may determine the starting time domain location for receiving each SIBX based on the starting radio frame and/or the starting radio sub-frame of each SIBX, may determine the time domain window for receiving each SIBX based on the starting time domain location of each SIBX and the SI WindowLength, and may receive SIBXs from the base station through the determined time domain window of each SIBX.

Although the present disclosure uses the above receiving operations to receive the SIBXs based on a determined reception order of each SIBX, example embodiments are not limited thereto, and the present disclosure may use other receiving operations known to those skilled in the art to receive the SIBXs based on a determined reception order of each SIBX.

FIG. 5 is an example illustrating the scheduling information list according to some example embodiments of the present disclosure. In some examples, the example scheduling information list as described with reference to FIG. 5 may implement aspects of or may be implemented by aspects of FIGS. 1-4. For example, a base station may transmit the example scheduling information list as described in the example in FIG. 5 (e.g., in a SIB1) to a UE to indicate an order of SIBXs to be communicated from the base station to the UE, where the base station and the UE represent respective elements as described with reference to FIGS. 1-4.

Referring to FIG. 5, a SIB1 may contain the scheduling information list (e.g., a schedulingInfoList) and the SI WindowLength. The scheduling information list may include information that indicates which SIBs there are in SI to be transmitted to the UE. Referring to FIG. 5, the SI may include a SIB24, a SIB2, and a SIB3.

The schedulingInfoList included in the scheduling information list may indicate the scheduling information for each SIB. Additionally, a si-WindowLength included in the SIB1 may indicate the SI WindowLength (e.g., in the unit of ms), and ms20 may indicate that the SI WindowLength is 20 ms. A si-Periodicity included in the scheduling information list may indicate the schedule period rfm of each SIB in the radio frame. A SIB-Type included in the scheduling information list may indicate the type of SIB being carried. In some embodiments, because the SIB2 is placed at the first position in the SchedulingInfo by default, the SIB-Type may not explicitly include SIB2 types. That is, the SIB-Type of the SIB2 may be omitted. The receive priority included in the scheduling information list may indicate the priority parameter.

In the example in FIG. 5, the schedulingInfoList may indicate that the length of the SchedulingInfo is three (3). That is, the schedulingInfoList indicates that 3 items (i.e., Item 0 through Item 2) are included. Item 0 indicates the SIB24 with a si-Periodicity of rf64, Item 1 indicates the SIB2 with a si-Periodicity of rf16, and Item 2 indicates the SIB3 with a si-Periodicity of rf32. The schedulingInfoList according to various example embodiments of the present disclosure may include 3 SIBXs, but a number of SIBXs and the types of SIBXs are not limited thereto.

A SI-window indicates the SI window (e.g., the time domain window). In the example in FIG. 5, one SI-window may include two (2) radio frames (SFNs). For example, the time domain window SI-window 1 may include radio frames SFN0 and SFN1, the time domain window SI-window 2 may include radio frames SFN2 and SFN3, and the time domain window SI-window 2 may include radio frames SFN4 and SFN5. The time domain window SI-window according to various example embodiments of the present disclosure may include two (2) radio frames, but the number of radio frames included in the time domain window is not limited thereto.

An original schedulingInfoList may indicate that the SIB2 is placed at the first location (i.e., order n=1) by default, and the SIB3 may be transmitted immediately after the SIB2. Because the base station knows which SIBs have been changed (e.g., the SIB24 will be modified), the base station may additionally assign a priority parameter of one (1) for the SIB24 in the scheduling information list (e.g., as illustrated in FIG. 5, the SIB24 has the identifier “receive priority: 1”), while the parameters of the unchanged SIB2 and SIB3 remain unchanged (e.g., the unchanged SIB2 and SIB3 are not additionally assigned priority parameters). Accordingly, based on the assigned priority parameter and the original schedulingInfoList, the new schedulingInfoList may indicate the order of the SIB24 first, then the SIB2, and then the SIB3 among the SIBXs (e.g., the SIB24 is at the top of the list, as illustrated in FIG. 5).

The time domain window corresponding to each SIB and the time domain location corresponding to each SIB may be determined by Equations 1, 2, and 3 as described above. Referring to Equations 1, 2, and 3, the smaller the order n may correspond to the earlier the time domain location.

In FIG. 5, referring to Equations 1, 2, and 3 described above, the SIB24 may have the order of 1 (i.e., first), the starting frame may be SFN0, and the starting sub-frame may be #0. Thus, the SIB24 may be transmitted within the SI-window 1 starting from the sub-frame #0 of SFN0. The SIB2 may have the order of 2 (i.e., second), the starting frame may be SFN2, and the starting sub-frame may be #0. Thus, the SIB2 may be transmitted within the SI-window2 starting from the sub-frame #0 of the SFN2. The SIB3 may have the order of 3 (i.e., third), the starting frame may be SFN4, and the starting sub-frame may be #0. Thus, the SIB3 may be transmitted within the SI-window3 starting from the sub-frame #0 of the SFN4.

In the present disclosure, although it will be described mainly with reference to the scheduling information list illustrated in FIG. 5, it will be understood that embodiments of the present disclosure are not limited thereto.

The apparatuses, units, modules, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and/or any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller, an arithmetic logic unit, a digital signal processor, a microcomputer, a programmable logic controller, a field-programmable gate array, a programmable logic array, a microprocessor, and/or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software.

For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and/or multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions and/or software include machine code that is directly executed by the processor or computer, such as machine code produced by a compiler. In another example, the instructions or software include higher-level code that is executed by the processor or computer using an interpreter. Persons and/or programmers of ordinary skill in the art may readily write the instructions and/or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include at least one of read-only memory (ROM), random-access programmable ROM (PROM), electrically erasable programmable ROM (EEPROM), random-access memory (RAM), dynamic RAM (DRAM), static RAM (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage devices, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and/or data structures in a non-transitory manner and providing the instructions or software and any associated data, data files, and/or data structures to a processor or computer so that the processor or computer may execute the instructions.

Although some example embodiments have been described, it should be understood by those skilled in the art that various changes in form and details may be made thereto without departing from the spirit and scope of the present disclosure as set forth by the claims.

1. A method for wireless communication at a base station, comprising:
transmitting, to a user equipment (UE), a change message indicating that system information is to be changed, the system information comprising a plurality of system information blocks (SIBs);
modifying a scheduling information list included in a system information block type1 (SIB1) of the plurality of SIBs;
transmitting, to the UE, the SIB1; and
transmitting, to the UE, one or more other SIBs other than the SIB1 among the plurality of SIBs based at least in part on a transmission order of the one or more other SIBs determined by the modified scheduling information list, wherein the change message indicates that at least one SIB of the one or more other SIBs is changed.

2. The method of claim 1, wherein transmitting the one or more other SIBs to the UE comprises:
periodically transmitting, to the UE, the one or more other SIBs based at least in part on the transmission order of the one or more other SIBs determined by the modified scheduling information list.

3. The method of claim 1, wherein modifying the scheduling information list comprises:
changing a transmission order of the at least one SIB that is changed to be earlier than a transmission order of remaining SIBs other than the at least one SIB among the one or more other SIBs.

4. The method of claim 3, wherein among respective SIBs of the at least one SIB, a sequence relationship embodied by the transmission order of the at least one SIB after the changing is the same as a sequence relationship embodied by the transmission order of the at least one SIB before the changing, and
among respective SIBs of the remaining SIBs, a sequence relationship embodied by the transmission order of the remaining SIBs is unchanged.

5. The method of claim 1, wherein modifying the scheduling information list comprises:
assigning respective priority parameters to the at least one SIB that is changed in the scheduling information list, wherein the priority parameters indicate that a transmission order of the SIBs to which the priority parameters are assigned is adjusted to be earlier than a transmission order of the SIBs to which the priority parameters are not assigned.

6. The method of claim 5, wherein the transmission order of the at least one SIB that is changed is determined according to values of the respective priority parameters, and
among respective SIBs of the at least one SIB, a sequence relationship embodied by the transmission order indicated by the values of the respective priority parameters of the at least one SIB is the same as a sequence relationship embodied by a transmission order of the at least one SIB before the changing.

7. The method of claim 1, wherein transmitting the one or more other SIBs to the UE comprises:
obtaining a time domain location of each SIB of the one or more other SIBs based at least in part on the determined transmission order of each SIB of the one or more other SIBs; and
transmitting the one or more other SIBs to the UE based at least in part on the obtained time domain location of each SIB of the one or more other SIBs.

8. The method of claim 7, wherein obtaining the time domain location of each SIB of the one or more other SIBs comprises:
determining a starting radio frame indicating the time domain location of each SIB of the one or more other SIBs based at least in part on the determined transmission order of each SIB of the one or more other SIBs, a SystemInformation (SI) WindowLength included in the SIB1, a time domain length of a single radio frame, a SI Periodicity of each SIB of the one or more other SIBs included in the scheduling information list, or a combination thereof.

9. The method of claim 8, wherein determining the starting radio frame of each SIB of the one or more other SIBs comprises:
obtaining an integer value of each SIB of the one or more other SIBs based at least in part on the determined transmission order of each SIB of the one or more other SIBs and the SI WindowLength included in the SIB1; and
determining the starting radio frame of each SIB of the one or more other SIBs based at least in part on the integer value of each SIB of the one or more other SIBs, the time domain length of the single radio frame, the SI Periodicity of each SIB of the one or more other SIBs included in the scheduling information list, or a combination thereof.

10. The method of claim 8, wherein transmitting the one or more other SIBs to the UE comprises:
transmitting, to the UE, each SIB of the one or more other SIBs with the SI Periodicity of each SIB of the one or more other SIBs included in the scheduling information list based at least in part on the starting radio frame of each SIB of the one or more other SIBs.

11. The method of claim 8, wherein obtaining the time domain location of each SIB of the one or more other SIBs comprises:
determining a starting radio sub-frame indicating the time domain location of each SIB of the one or more other SIBs based at least in part on the determined transmission order of each SIB of the other SIBs, the SI WindowLength included in the SIB1, a number of radio sub-frames included in the single radio frame, or a combination thereof.

12. The method of claim 11, wherein determining the starting radio sub-frame of each SIB of the one or more other SIBs comprises:
obtaining an integer value of each SIB of the one or more other SIBs based at least in part on the determined transmission order of each SIB of the one or more other SIBs and the SI WindowLength included in the SIB1; and
determining the starting radio sub-frame of each SIB of the one or more other SIBs based at least in part on the integer value of each SIB of the one or more other SIBs and the number of radio sub-frames included in the single radio frame.

13. The method of claim 11, wherein transmitting the one or more other SIBs to the UE comprises:
determining a starting time domain location for transmitting each SIB of the one or more other SIBs based at least in part on the starting radio frame and the starting radio sub-frame of each SIB of the one or more other SIBs;
determining a time domain window for transmitting each SIB of the one or more other SIBs based at least in part on the starting time domain location for transmitting each SIB of the one or more other SIBs and the SI WindowLength included in the SIB1; and
transmitting the one or more other SIBs to the UE through the determined time domain window of each SIB of the one or more other SIBs.

14. A method for wireless communication at a user equipment (UE), comprising:
receiving, from a base station, a change message indicating that system information is to be changed, the system information comprising a plurality of system information blocks (SIBs);
receiving, from the base station, a system information block type1 (SIB1) among the plurality of SIBs, the SIB1 including a scheduling information list;
determining a reception order of one or more other SIBs other than the SIB1 among the plurality of SIBs based at least in part on the scheduling information list; and
receiving, from the base station, the one or more other SIBs based at least in part on the determined reception order of the one or more other SIBs, wherein the change message indicates that at least one SIB of the one or more other SIBs is changed.

15. The method of claim 14, wherein receiving the one or more other SIBs from the base station comprises:
periodically receiving, from the base station, the one or more other SIBs based at least in part on the determined reception order of the one or more other SIBs, wherein, when a first portion of the one or more other SIBs is received in a current period, a second portion other than the first portion of the one or more other SIBs received in a previous period is invoked.

16. The method of claim 14, wherein a reception order of the at least one SIB that is changed is earlier than a reception order of remaining SIBs other than the at least one SIB among the one or more other SIBs.

17. The method of claim 16, wherein among respective SIBs of the at least one SIB that is changed, a sequence relationship embodied by a reception order of the respective SIBs after the changing is the same as a sequence relationship embodied by a default reception order of the respective SIBs before the changing.

18. The method of claim 17, wherein determining the reception order of the one or more other SIBs based at least in part on the scheduling information list comprises:
obtaining priority parameters from the scheduling information list;
determining SIBs of the plurality of SIBs to which priority parameters are assigned; and
determining a reception order of the SIBs to which priority parameters are assigned to be earlier than a reception order of SIBs to which the priority parameters are not assigned.

19. The method of claim 14, wherein determining the reception order of the one or more other SIBs based at least in part on the scheduling information list comprises:
determining the reception order of the at least one SIB that is changed based at least in part on priority parameters obtained from the scheduling information list; and
determining a reception order of remaining SIBs other than the at least one SIB that is changed among the one or more other SIBs based at least in part on a default reception order of the remaining SIBs obtained from the scheduling information list, wherein, among respective SIBs of the remaining SIBs, a sequence relationship embodied by a reception order of the respective SIBs of the remaining SIBs is the same as a sequence relationship embodied by the default reception order of the respective SIBs of the remaining SIBs.

20.-26. (canceled)

27. An apparatus for wireless communication at a base station, comprising:
a transceiver, configured to transmit and receive signals to and from outside the base station; and
a processor, configured to control the transceiver to:
transmit, to a user equipment (UE), a change message indicating that system information is to be changed, the system information comprising a plurality of system information blocks (SIBs);
modify a scheduling information list included in a system information block type1 (SIB1) of the plurality of SIBs;
transmit, to the UE, the SIB1; and
transmit, to the UE, one or more other SIBs other than the SIB1 among the plurality of SIBs based at least in part on a transmission order of the one or more other SIBs determined by the modified scheduling information list, wherein the change message indicates that at least one SIB of the one or more other SIBs is changed.

28. (canceled)
